(19) United States
(12) Patent Application Publication
(10) Pub. No.: US 2006/0237658 A1
(43) Pub. Date: Oct. 26, 2006

(54) Transilluminator with ultraviolet light emitting diode array

(76) Inventor: Alex Waluszko, Upland, CA (US)

Correspondence Address: JAMES E. BRUNTON, ESQ., P. O. BOX 29000, GLENDALE, CA, 91209, US

(21) Appl. No.: 11/473,649

(22) Filed: Jun. 22, 2006

Related U.S. Application Data
(63) Continuation-in-part of application No. 10/842,909, filed on May 10, 2004, now abandoned.

(51) Int. Cl. G01J 1/42

(52) U.S. Cl. 250/372

(57) ABSTRACT

A method and apparatus for genomic or proteomic research to visualize fluorescent labeled DNA, RNA or protein samples that have been separated for documentation and analysis. The apparatus includes a novel radiation source for uniformly irradiating the samples which comprises an array of UV LEDS. In one form of the invention the apparatus also includes a first conversion plate that is carried by the housing at a location intermediate the radiation source and the sample supporting platform for converting the radiation emitted from the source to radiation at a second wavelength.

### BACKGROUND OF THE INVENTION

This is a Continuation-in-Part application of a co-pending application U.S. Ser. No. 10/842,909 filed May 10, 2004.

### FIELD OF THE INVENTION

The present invention relates generally to ultraviolet radiation devices. More particularly, the invention concerns an apparatus for use in genomic or proteomic research to visualize fluorescent labeled DNA, RNA or protein samples that have been separated for documentation and analysis.

### DISCUSSION OF THE PRIOR ART

By way of brief background, ultraviolet (UV) light, which is electromagnetic radiation in the region of the spectrum located between X-rays and visible light, is typically divided into three principal ranges, namely long wave, mid-range, and short wave. For each of these UV ranges specific applications have been developed.

As a general rule, the desired ultraviolet wavelength is obtained from a fluorescent-style tube that is an electric discharge device that uses a low-pressure mercury vapor arc to generate ultraviolet energy. The ultraviolet energy released in typical, commercially available fluorescent tubes is primarily at the wavelength of about 254 nanometers.

However, the fluorescent tubes can be modified to release other ultraviolet wavelengths by the use of phosphors which have the ability to absorb the ultraviolet energy and re-radiate it in other wavelengths. For example, long wave ultraviolet of about 365 nanometers and mid-range ultraviolet of about 300 nanometers are created by coating the inside of the fluorescent tubes with the proper phosphors which convert the short wave ultraviolet.

In the past ultraviolet irradiation of selected articles has been accomplished using a single UV range fluorescent tube mounted within a suitable enclosure. In order to eliminate white light generated by the UV tube, some prior art devices make use of a UV transmitting ambient or visible light blocking filter that is typically mounted in front of the UV tube.

By way of example, U.S. Pat. No. 5,175,347 issued to the present inventor describes an apparatus for irradiating an object such as a specimen of material with ultraviolet radiation at a selected long, short or mid-wave length. Similarly, U.S. Pat. No. 3,936,186 issued to Boland, et al., discloses an apparatus for exposing diazo printing plates and the like of the character that are used in the graphic arts field. In like manner, U.S. Pat. No. 5,288,647 issued to Zimlich, Jr., et al., relates to a method by which polynucleotide specimens can be irradiated particularly for the purpose of fixing them to a substrate. Similarly, U.S. Pat. No. 5,736,744 issued to Johannsen, et al., in which the present inventor is named as a co-inventor, discloses a wave length shifting filter separate and apart from a transilluminator. The wavelength shifting filter uses phosphors in a flat array to provide a selection of visible wavelengths.

U.S. Pat. No. 5,951,838 issued to Heffelfinger, et al., concerns a method and apparatus for achieving uniform illumination of an electrophoresis apparatus. In the Heffelfinger, et al., method, uniform illumination is achieved by scanning the light source across the sample gel in a direction perpendicular to the axis of the source. The light source is comprised of one or more light bulbs placed in a light tray. Variations in light intensity near the source end portions is minimized using a variety of techniques including extended light bulbs, filters, reflectors, and diffusers, or supplemental sources.

The standard prior art method for separating, identifying and purifying biological samples is electrophoresis through a gel. The electrophoresis process is simple and well understood today. It is commonly used in one dimension separation where distinct bands of distinct biologicals are formed, or in two dimension separation where distinct spots or bands are formed.

Generally, following the process of electrophoretic separation, the separated biological samples are stained with a fluorescent dye, such as ethidium bromide. A set of multiple visible fluorescing dyes can be utilized that are capable of identifying specifically separated biological samples. These dyes have the ability to specifically attach (tag) themselves to specific biological samples and fluoresce in different visible wavelengths.

After the sample is dyed it is exposed to an ultraviolet radiation source, normally within the spectral bandwidth of mid-range ultraviolet (280 nm-320 nm). This range generally provides for the best and brightest wave shift conversion of the dye. During exposure, the dye labeled, separated biological sample is visible for viewing, documentation and further analysis. It is to be noted that other wavelengths of ultraviolet, such as short wave ultraviolet (generally considered as 254 nm), long wave ultraviolet (320-400 nm), broadband ultraviolet and a combination of short wave, mid-range and long wave can also be used to generate the fluorescent wave shift action of the dyes.

Although excitation of the fluorescent labeled biological sample is at times possible with visible wavelengths and light boxes that generate visible wavelengths, such as 420 nm or 480 nm, it is generally understood that UV excitation allows larger stoke shifts (that is, the discrimination between excitation and emission wavelengths), enables higher signal to noise ratios and provides greater sensitivity.

A commonly used prior art tool for illuminating electrophoretically separated gels is the ultraviolet transilluminator (light box). These light boxes, generally comprise a single wavelength set of ultraviolet producing fluorescent lamps. These lamps are generally horizontally mounted within the light box behind a window upon which the dye-labeled sample rests. The window typically comprises an ultraviolet transmitting, ambient (visible) light blocking filter material. Other ultraviolet light boxes are commercially available that provide dual UV wavelength combinations of 254 nm/365 nm, 254 nm/302 nm and 365 nm/302 nm. In this regard, commercially available mid-range ultraviolet light boxes interchangeably use the wavelength designations 300 nm, 302 nm, 310 nm or 312 nm, since the UV bandwidth output of these wavelength designations is substantially the same. Additionally, UV light boxes are commercially available that provide all three UV wavelengths of 254 nm, 302 nm and 365 nm. However, substantially all presently commercially available ultraviolet transilluminators (light boxes) use commercially available ultraviolet producing lamps that singly provide UV wavelengths in 365 nm (UV-A) bandwidth, 302 nm (UV-B bandwidth) and 254 nm (UV-C bandwidth).

Another device used to capture fluorescent labeled biological samples is commercially available from Bio-Rad, Inc. of Hercules, Calif. under the name and style FLUOR S MULTIMAGER. This device uses a single broadband (290 nm-365 nm) ultraviolet fluorescent lamp. This ultraviolet fluorescent-style tube lamp is horizontally mounted below the sample holding window and is typically scanned across the sample permitting the acquisition of the fluorescent signal via a charge coupled device (CCD) based camera system. This configuration limits the actual viewing of the fluorescent labeled sample by the researcher in real-time. The previously mentioned U.S. Pat. No. 5,951,838 issued to Heffelfinger, et al., and entitled “Method and Apparatus for Correcting Illumination Non-Uniformities” describes this method in greater detail.

As a general rule, all commercially available ultraviolet light boxes use 4, 5, or 6 fluorescent-style UV generating lamps. These UV fluorescent lamps (254 nm, 302 nm, 365 nm or broadband) are typically commercially available in 4 watt, 6 watt, 8 watt, 15 watt and 25 watt styles and in varying lengths. The lamps are normally configured in a horizontal pattern and are generally superimposed over a reflective aluminum reflector. Typically, a UV transmitting-ambient visible light blocking filter is positioned above the lamps.

It is well understood that conventional ultraviolet generating fluorescent-style tube lamps of the type described in the preceding paragraph generate ultraviolet radiation in an arc formed between the electrodes in the lamp. However it is not well known that the intensity or output of this type of lamp diminishes from the center point of the arc towards the arc origination points. Accordingly, in virtually all wattages and configurations, the presently commercially available lamps provide a sample illumination surface that is substantially non-uniform. This problem of non-uniform UV illumination of fluorescent biologically labeled samples has been addressed in the past by the development of data manipulation and correction software that is specially designed to account for UV background on a fluorescent labeled sample. A description of such software and of its use is discussed in detail in U.S. Pat. Nos. 5,951,838 and 5,897,760 issued to Heffelfinger, et al.

Other prior art devices suggest the use of a cold cathode type serpentine grid to generate a more uniform visible light for use in LCD and photographic film viewing background lighting. A description of such prior art devices can be found in U.S. Pat. Nos. 5,731,658 and 6,069,441 issued to Lengyel, et al.

Commercially available alternatives to the ultraviolet light box are available in devices that use lasers to illuminate the fluorescent labeled biological samples. Typically, these devices rely on laser light sources to illuminate the fluorescent “tagged” samples to excite the samples. In such devices, the laser source is scanned serially to excite each sample.

As will be better understood from the discussion that follows, the present invention overcomes many of the drawbacks of the prior art devices.

### SUMMARY OF THE INVENTION

The present invention provides a method and apparatus for use in genomic or proteomic research to visualize fluorescent labeled DNA, RNA or protein samples that have been separated for documentation and analysis. By way of summary, one form of the apparatus of the invention comprises a housing having interconnected top, bottom and side walls defining an internal chamber and a sample supporting platform having a sample supporting area and radiation means disposed within the chamber for uniformly irradiating the sample supporting area with ultraviolet light at a first wavelength. The radiation means uniquely comprises an ultraviolet light emitting diode array for emitting ultraviolet radiation. In one form of the invention, the apparatus also includes a first conversion means that is removably carried by the housing at a location intermediate the radiation means and the sample supporting platform for converting the radiation emitted from the source of ultraviolet radiation to radiation at a second wavelength.

With the foregoing in mind, it is an object of the present invention to provide a method and apparatus in which the uniformity of excitation radiation across the sample supporting surface of the apparatus is vastly improved when compared with the non-uniformity of radiation across the sample supporting surface of prior art transilluminators.

Another object of the invention is to provide a method and apparatus of the character described in the preceding paragraphs in which meaningful, quantitative side-by-side comparisons of samples are possible.

Another object of the invention is to provide a method and apparatus in which sequential analysis of several samples is greatly simplified and is substantially more accurate than is possible with prior art transilluminators because of the minimal effect on excitation intensity of sample positioning on the sample support surface. More particularly, an object of the invention is to provide a method and apparatus in which the same sample will give similar fluorescent intensities regardless of where the sample is placed on the sample supporting surface of the apparatus.

Another object of the invention is to provide a novel radiation source for uniformly irradiating a spaced-apart surface with an ultraviolet radiation, the radiation source comprising a uniquely configured array constructed from a multiplicity of closely spaced-apart ultraviolet light emitting diodes.

The foregoing as well as other objectives of the invention will become apparent from the description which follows.

### BRIEF DESCRIPTION OF THE DRAWINGS

FIG. 1 is a generally perspective view of one form of the apparatus of the invention for uniformly illuminating molecular samples with ultraviolet radiation.

FIG. 2 is a side-elevational view, partly broken away to show internal construction, of the apparatus illustrated in FIG. 1.

FIG. 3 is a generally perspective, exploded view of the primary operating components of the apparatus of the invention shown in FIGS. 1 and 2.

FIG. 4 is an enlarged cross-sectional, exploded view of the primary operating components of the apparatus of the invention.

FIG. 5 is a cross-sectional view of one form of the ultraviolet light emitting radiation array of the apparatus of the invention.

### DESCRIPTION OF THE INVENTION

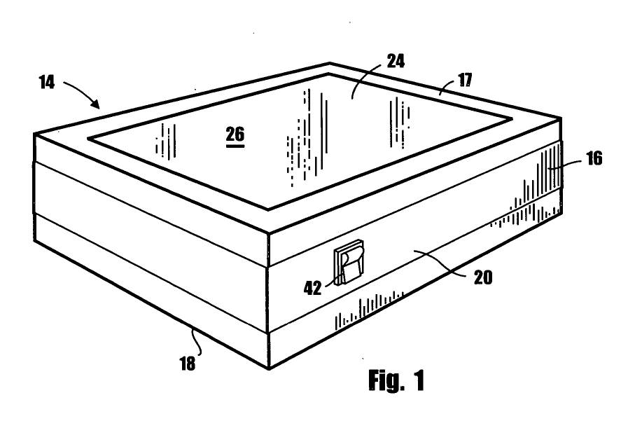

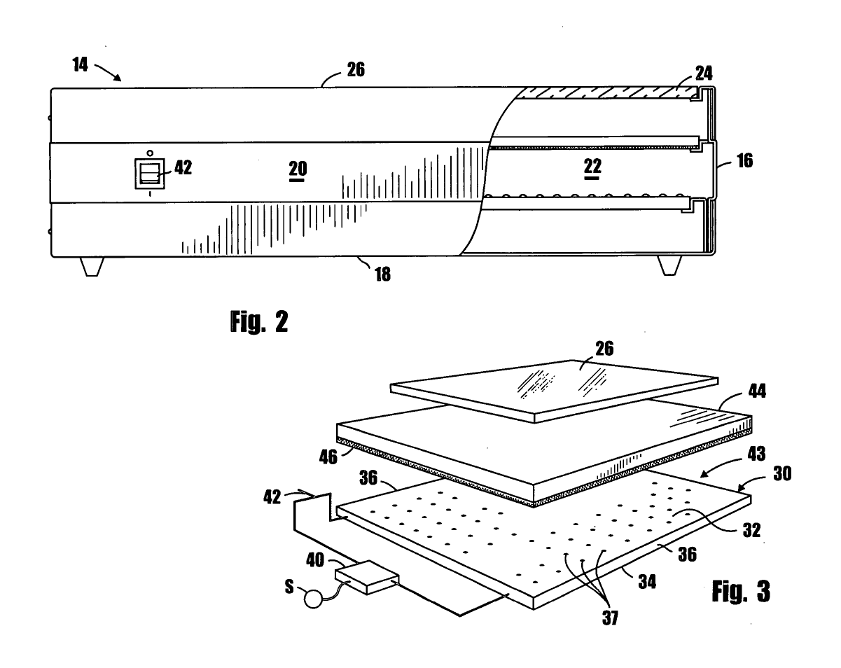

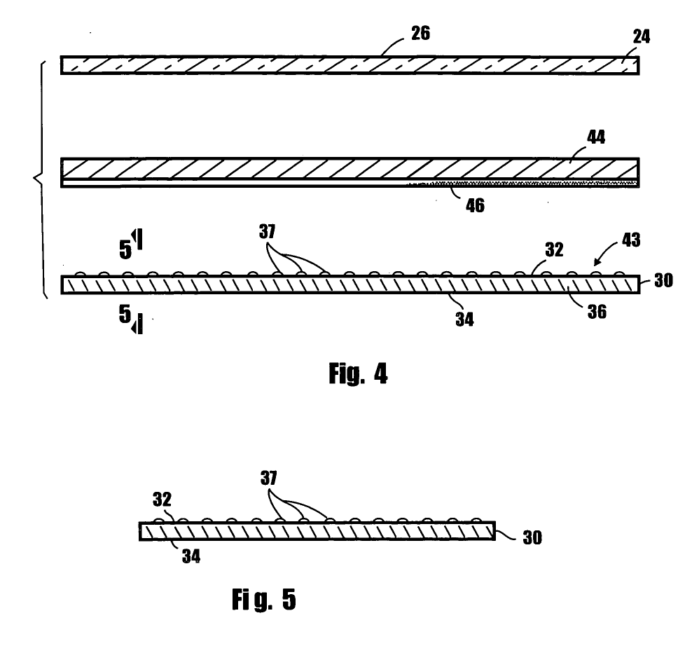

Referring to the drawings and particularly to FIG. 1, one embodiment of the apparatus of the invention for uniformly illuminating molecular samples with ultraviolet radiation is there shown and generally designated by the numeral 14. The apparatus of this form of the invention comprises a housing 16 having interconnected top, bottom and sidewalls 17, 18, and 20 respectively that define an internal chamber 22 (FIG. 2). Carried by top wall 17 is a sample supporting surface or area 26.

An important aspect of the apparatus of the present invention comprises irradiation means disposed within chamber 22 for uniformly irradiating the sample supporting area with ultraviolet light at a first wavelength. This novel irradiation means here comprises a base 30 having interconnected top, bottom and side walls 32, 34 and 36 respectively. Mounted on the top wall 32 of base 30 is a multiplicity of spaced-apart ultraviolet light emitting diodes 37. Also forming a part of the novel radiation means of this form of the invention is electric circuit means which are connected to the ultraviolet light emitting diodes 37 for energizing the diodes. As best seen in FIG. 3, the electric circuit means here includes a conventional power supply 40 that is appropriately interconnected with a source “S” of alternating current and a switch means, here provided as a conventional switch 42. Switch 42 is disposed between the power supply and the multiplicity of ultraviolet light emitting diodes 37 and functions to control the flow of current to the diodes.

Diodes 37 can be all of the same UV wavelength, for example, of a long wavelength or, alternatively, selected diodes can be of a long wave length, others of a mid wavelength and still others of a short wavelength. Similarly, the samples to be irradiated can be selectively positioned on surface area 26 for selected irradiation by diodes 37 of varying wavelengths.

However, short wavelength, high-power output UV LEDs, such as those developed at Sandia National Laboratories of Albuquerque, N.M. have proven quite satisfactory for use as the radiation means of the present invention. The Sandia devices comprise a sapphire substrate with conductive layers of aluminum gallium nitride. These devices are described more fully in a Sandia National Laboratory News Release dated Nov. 18, 2003 and more detailed information concerning the devices can be obtained from Sandia National Laboratories.

As will be discussed in greater detail hereinafter, the novel radiation means of the present invention is custom-designed and constructed to uniquely provide uniform illumination of all, or selected portions of, the sample supporting area 26.

An important aspect of the apparatus of the present invention is the previously mentioned, first conversion means that it is carried by housing 16 at a location intermediate the radiation means and the superimposed supporting surface 26. This important first conversion means functions to convert the radiation emitted from the radiation means, or source of ultraviolet radiation, 43 at a first wavelength of, for example 275 nanometers to radiation at a second wavelength of on the order of between 302 nm and 365 nm. However, it is to be understood that the radiation means can emit radiation at wavelengths of between about 250 and 280 nm.

The first wavelength conversion means here comprises a borosilicate conversion plate 44 that is carried within the internal chamber of housing 16 at a location intermediate the sample supporting platform and the UV source 43. More particularly, the lower surface of plate 44 (FIG. 3) is provided with a conventional wave-shifting phosphor coating 46. As is well known in the art, phosphors are compounds that are capable of emitting useful quantities of radiation in the visible and/or ultraviolet spectrums upon excitation of the material by an external energy source. Due to this property, phosphor compounds have long been utilized in cathode ray tube (CRT) screens for televisions and similar devices. Typically, inorganic phosphor compounds include a host material doped with a small amount of an activator ion. In recent years, phosphor compounds, including phosphors in particular form, have been used in display devices, decorations, cathode ray tubes and fluorescent lighting fixtures. Luminescence or light emission by phosphor particles may be stimulated by application of heat (thermo luminescence), light (photo luminescence), high energy radiation (e.g., X-rays or e-beams), or electric fields (Electro luminescence). A comprehensive discussion of various types of phosphors can be found in U.S. Pat. No. 6,193,908 issued to Hampden-Smith, et al.

In using the apparatus of the invention, the samples to be evaluated are placed upon the supporting surface 26. This done, the irradiation means, or novel diode array is energized to uniformly produce UV radiation at a wavelength of about 275 nanometers. This radiation is then converted by the conversion means to radiation at a second wavelength for uniformly exciting the samples resting on the sample supporting surface.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An apparatus for uniformly illuminating molecular samples with ultraviolet radiation comprising:
(a) a housing including an internal chamber and a sample supporting platform having a sample supporting area;
(b) irradiation means disposed within said chamber for uniformly irradiating said sample supporting area with ultraviolet light at a first wavelength, said irradiation means comprising an irradiation assembly including:
(i) a base having interconnected top, bottom and side walls; and
(ii) a multiplicity of spaced-apart ultraviolet light emitting diodes connected to said base; and
(iii) electric circuit means connected it to said ultraviolet light emitting diodes with for energizing said diodes.

2. The apparatus as defined in claim 1 further including a first conversion means removably carried by said housing at a location intermediate said irradiation means and said sample supporting platform for converting the radiation emitted from said irradiation means to radiation at a second wavelength, said first conversion means comprising a top plate.

3. The apparatus as defined in claim 2 in which said top plate has an upper surface and a lower surface, said lower surface being coated with phosphor.

4. The apparatus as defined in claim 2 in which said irradiation means emits radiation at a wave length of about 275 nanometers and in which said first conversion means converts the radiation to approximately 365 nanometers.

5. The apparatus as defined in claim 2 in which said irradiation means emits radiation at a wave length of about 275 nanometers and in which said first conversion means converts the radiation to approximately 302 nanometers.

6. The apparatus as defined in claim 2 in which said electric circuit means includes a power supply and an electrical conduit for interconnecting said power supply with a source of alternating current.

7. The apparatus as defined in claim 6 in which said electric circuit means further includes switch means disposed between said power supply and said multiplicity of ultraviolet light emitting diodes for controlling the flow of electricity to said diodes.

8. An apparatus for uniformly illuminating molecular samples with ultraviolet radiation comprising:
(a) a housing including an internal chamber and a sample supporting platform having a sample supporting area;
(b) irradiation means disposed within said chamber for uniformly irradiating said sample supporting area with ultraviolet light at a first wavelength, said irradiation means comprising an irradiation assembly including:
(i) a base having interconnected top, bottom side and end walls;
(ii) a multiplicity of spaced-apart ultraviolet light emitting diodes connected to said top wall; and
(iii) electric circuit means for providing electric power to said diodes; and
(c) a first conversion means removably carried by said housing at a location intermediate said irradiation means and said sample supporting platform for converting the radiation emitted from said irradiation means to radiation at a second wavelength.

9. The apparatus as defined in claim 8 in which said first conversion means comprises a borosilicate plate having a lower surface coated with phosphor.

10. The apparatus as defined in claim 8 in which said irradiation means emits radiation at a wave length of about 275 nanometers and in which said first conversion means converts the radiation to approximately 365 nanometers.

11. The apparatus as defined in claim 8 in which said irradiation means emits radiation at a wave length of about 275 nanometers and in which said first conversion means converts the radiation to approximately 302 nanometers.

12. The apparatus as defined in claim 8 in which said electric circuit means includes a power supply and an electrical conduit for interconnecting said power supply with a source of alternating current.

13. The apparatus as defined in claim 8 in which said sample supporting platform comprises an ultraviolet transmitting plate.

14. The apparatus as defined in claim 8 in which said electric circuit means comprises a source of electric current and an electrical conduit interconnecting said light emitting diodes with said source of electric current.

15. An apparatus for uniformly illuminating molecular samples with ultraviolet radiation comprising:
(a) a housing including an internal chamber and a sample supporting platform having a sample supporting area;
(b) irradiation means disposed within said chamber for uniformly irradiating said sample supporting area with ultraviolet light at a first wavelength, said irradiation means comprising an irradiation assembly including:
(i) a base having interconnected top, bottom and side walls;
(ii) a multiplicity of spaced-apart ultraviolet light emitting diodes connected to said base, said diodes emitting radiation at varying wavelengths; and
(iii) electric circuit means connected to said ultraviolet light emitting diodes for energizing said diodes; and
(c) first conversion means removably carried by said housing at a location intermediate said irradiation means and said sample supporting platform for converting the radiation emitted from said irradiation means to radiation at a second wavelength, said first conversion means comprising a top plate.

16. The apparatus as defined in claim 15 in which selected ultraviolet light emitting diodes of said multiplicity of diodes emit radiation at a long wavelength and in which selected ultraviolet light emitting diodes of said multiplicity of diodes emit radiation at a short wavelength.

17. The apparatus as defined in claim 16 in which selected ultraviolet light emitting diodes of said multiplicity of diodes emit radiation at a mid wavelength.
